(19) United States
(12) Patent Application Publication
(10) Pub. No.: US 2001/0014553 A1
(43) Pub. Date: Aug. 16, 2001

(54) Terminal and connecting method of circuit body and the terminal

(75) Inventor: Kentaro Nagai, Shizuoka-ken (JP)

Correspondence Address: FINNEGAN, HENDERSON, FARABOW, GARRETT & DUNNER, L.L.P., 1300 I Street, N.W., Washington, DC, 20005, US

(73) Assignee: Yazaki Corporation

(21) Appl. No.: 09/779,738

(22) Filed: Feb. 9, 2001

(30) Foreign Application Priority Data
Feb. 15, 2000 (JP) P 2000-36995

(51) Int. Cl. H01R 4/24; H01R 4/26; H01R 11/20

(52) U.S. Cl. 439/422

(57) ABSTRACT

A first piercing member is raised from a base member. The first piercing member is for piercing a conductor of a circuit body to be electrically joined. A second piercing member is raised from the base member and is apart from the first piercing member. A reinforcing member is between the first piercing member and the second piercing member. The reinforcing member is raised from the base member. The reinforcing member is connected to the first piercing member and the second piercing member.

### BACKGROUND OF THE INVENTION

The present invention relates to a terminal connected in a conductive manner by piercing through a circuit body such as a flexible flat cable (FFC) and a flexible print circuit (FPC) and a connecting method of a circuit body and the terminal.

As a structure of this type of terminal, there is one disclosed in Japanese Patent Application Laid-open No. 4-359875, for example. Connection of the flat circuit bodies to each other and the flat circuit body to another object of connection in a conductive manner by the terminal in Japanese Patent Application Laid-open No. 4-359875 is carried out by the following method.

First, two plate-shaped flat circuit bodies applied with insulation coatings on their upper and lower faces are stacked in a stepped manner in which edge parts of the respective flat circuit bodies are displaced from each other. Then, the flat circuit bodies are placed on a base part of the terminal including a set of three crimp pieces (piercing projections) standing and having two kinds of heights. Then, the crimp pieces of the terminal pierce through two layers and a single layer of the flat circuit bodies from below. Distal ends of the crimp pieces respectively projecting from an upper face of the flat circuit body are bent downward such that the distal ends of the crimp pieces break the insulation coating on the upper face to bring in contact with conductor parts.

In this manner, the two flat circuit bodies are connected to each other in the conductive manner through the crimp pieces and are connected to the object of connection in the conductive manner when a fitting part of the terminal is inserted into a connector.

### SUMMARY OF THE INVENTION

Since the crimp pieces, however, need to be high to some degree, there is possibility of buckling of the crimp pieces at base ends thereof due to a load of a crimping jig in a piercing operation in which the crimp pieces pierce through the flat circuit bodies from below.

Therefore, it is an object of the present invention to provide a terminal having sufficient strength of conduction projections and a connecting method of a flat circuit body to the terminal.

To achieve the object, a first aspect of the invention provides the following terminal. The terminal includes a base member. A first piercing member is raised from the base member. The first piercing member is for piercing a conductor of a circuit body to be electrically joined. A second piercing member is raised from the base member and is apart from the first piercing member. A reinforcing member is between the first piercing member and the second piercing member. The reinforcing member is raised from the base member. The reinforcing member is connected to the first piercing member and the second piercing member.

Preferably, the first piercing member has an acute shape.

Preferably, the second piercing member has an acute shape.

Preferably, the reinforcing member is lower than the first piercing member and second piercing member.

A second aspect of the invention provides the following connecting method of a circuit body and a terminal of claim 1.

The steps include placing a circuit body on first and second piecing members; pressing the circuit body to the first and second piercing members, piercing the first and second piercing members through a conductor of the circuit body; and pressing the first and second piercing members to curve first parts thereof extending from second parts thereof connected with the reinforcing member therebetween.

Preferably, the circuit body is interposed between the first and second piercing members and a curved recessed part of a jig.

### BRIEF DESCRIPTION OF THE ACCOMPANYING DRAWINGS

FIG. 1 is a general perspective view of a terminal of the present embodiment; and

FIGS. 2 and 3 are explanatory views of a piercing step in a section taken along a line A1-A1 in FIG. 1.

### DETAILED DESCRIPTION OF THE PREFERRED EMBODIMENT

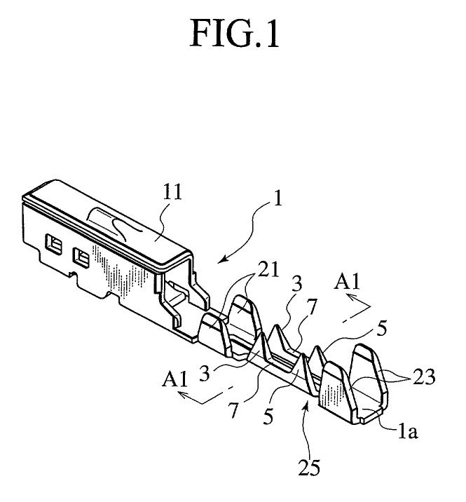

An embodiment of the present invention will be described by FIGS. 1 to 3.

As shown in FIG. 1, a terminal 1 has on a front side thereof an electrically contacting part 11 in a shape of a rectangular tube and connected to another terminal. On a rear side of the contacting part 11, a bottom plate part 1a is formed to extend by integral molding. On front and rear sides of the bottom plate part 1a, pairs of bent retaining pieces (crimped parts) 21, 23 are respectively formed to be bent upward from opposite side edges of the bottom plate part. Furthermore, a conduction projection 25 standing in the same direction as the pairs of retaining pieces 21 and 23 from the opposite side edges of the bottom plate part 1a is formed between the pairs of retaining pieces 21 and 23.

The projection 25 is formed of a pair of first piercing projections 3 formed on a side of the retaining pieces 21 to face each other and a pair of second piercing projections 5 formed on a side of the retaining pieces 23. The first and second projections 3 and 5 have distal ends of acute angles and are generally formed into shapes of angles. Widths of the first and second projections 3 and 5 are formed to be smaller than widths of the retaining pieces 21 and 23. Furthermore, wall parts 7 are formed between the pair of first projections 3 and the pair of second projections 5. The wall parts 7 stand from the opposite edges of the bottom plate part 1a and are lower than the distal ends of the first and second projections 3 and 5.

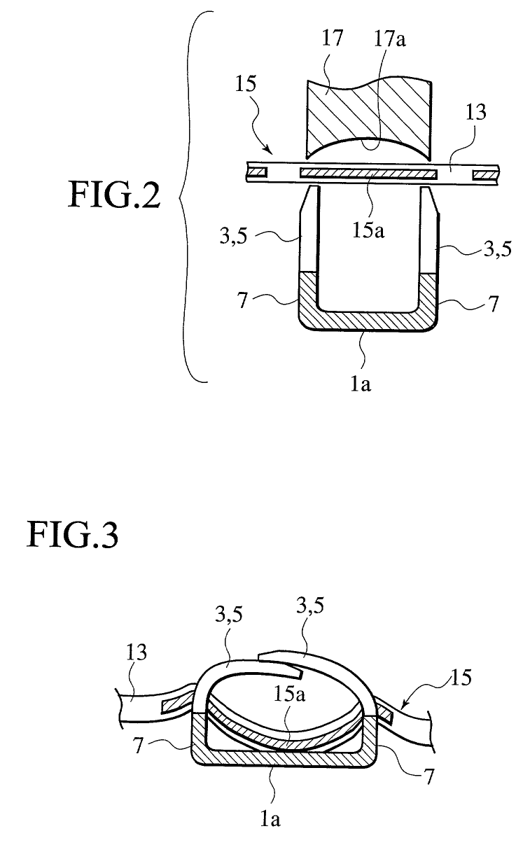

Next, a connecting method of a flat circuit body 15 to the terminal will be described. The flat circuit body 15 is one in which a plurality of conductor parts 15a made of rolled copper foil or the like are disposed in parallel and covered with a base film, or insulation coating, 13 by using an adhesive as shown in FIG. 2.

As shown in FIG. 2, the circuit body 15 is placed over the first and second projections 3 and 5. Then, a crimping jig 17 is positioned on an upper part of the circuit body 15. In this state, the jig 17 is moved down toward the circuit body 15 and the circuit body 15 is pressed toward the terminal 1. If the circuit body 15 is pressed toward the terminal 1, the distal end parts of the first and second projections 3 and 5 pierce through the insulation coating 13 and through the conductor part 15a. Thus, the terminal 1 and the conductor part 15a are connected in a conductive manner by the piercing operation.

If the jig 17 is further moved down toward the terminal 1, the distal end parts of the first and second projections 3 and 5 are curved and deformed along a recessed face 17a of the jig 17 in such directions as to approach each other and finally overlap each other as shown in FIG. 3.

When the distal end parts of the first and second projections 3 and 5 are deformed by the piercing operation, there is no possibility of buckling of the first and second piercing projections 3 and 5 because the wall parts 7 connect the first and second piercing projections 3 and 5 and therefore bases on a bottom plate part 1a side of the first and second piercing projections 3 and 5 have high rigidity and are less liable to be deformed.

The wall parts 7 may have heights from the bottom plate part 1a up to heights slightly smaller than the distal end parts of the first and second projections 3 and 5, i.e., parts that are finally curved and bent to overlap each other as shown in FIG. 3.

By providing the connecting wall parts between the first and second piercing projections, the first and second piercing projections do not buckle at base parts thereof but pierce through when the first and second piercing projections pierce through the conductor part.

Since the base parts of the first and second piercing projections are reinforced with the connecting wall parts between the first and second piercing projections, the piercing operation without buckling is carried out and efficiency of the operation is enhanced.

While preferred embodiments of the present invention have been described using specific terms, such description is for illustrative purposes, and it is to be understood that changes and variations may be made without departing from the spirit or scope of the following claims.

What is claimed is:

1. A terminal comprising:
a base member;
a first piercing member raised from the base member, the first piercing member for piercing a conductor of a circuit body to be electrically joined;
a second piercing member raised from the base member, the second piercing member being apart from the first piercing member; and
a reinforcing member between the first piercing member and the second piercing member, the reinforcing member being raised from the base member, the reinforcing member being connected to the first piercing member and the second piercing member.

2. A terminal according to claim 1,
wherein the first piercing member has an acute shape.

3. A terminal according to claim 1,
wherein the second piercing member has an acute shape.

4. A terminal according to claim 1,
wherein the reinforcing member is lower than the first piercing member and second piercing member.

5. A connecting method of a circuit body and a terminal of claim 1, comprising the step of;
placing a circuit body on first and second piecing members;
pressing the circuit body to the first and second piercing members, piercing the first and second piercing members through a conductor of the circuit body; and
pressing the first and second piercing members to curve first parts thereof extending from second parts thereof connected with the reinforcing member therebetween.

6. A connecting method of a circuit body and a terminal according to claim 5,
wherein the circuit body is interposed between the first and second piercing members and a curved recessed part of a jig.
